(19) United States
(12) Patent Application Publication
(10) Pub. No.: US 2024/0176044 A1
(43) Pub. Date: May 30, 2024

(54) SPACE DIGITAL TWIN DEVICE AND METHOD

(71) Applicant: Korea Aerospace Research Institute, Daejeon (KR)

(72) Inventors: OKCHUL JUNG, Daejeon (KR); YOUEYUN JUNG, Daejeon (KR); JAEDONG SEONG, Daejeon (KR); SAEHAN SONG, Daejeon (KR); MYEONGSHIN LEE, Daejeon (KR); DAEWON CHUNG, Daejeon (KR)

(21) Appl. No.: 18/523,758

(22) Filed: Nov. 29, 2023

(30) Foreign Application Priority Data
Nov. 30, 2022 (KR) 10-2022-0164459

(51) Int. Cl. G01V 20/00

(52) U.S. Cl. CPC G01V 20/00

(57) ABSTRACT

A space digital twin device and a space digital twin method are disclosed. The space digital twin device includes a digital twin unit configured to simulate a space system as a twin space system, a digital control unit configured to transplant control for the space system to control for the twin space system, and a digital output unit configured to visualize a content generated according to the control for the twin space system.

### CROSS-REFERENCE TO RELATED APPLICATION

This application claims the benefit of Korean Patent Application No. 10-2022-0164459 filed on Nov. 30, 2022, in the Korean Intellectual Property Office, the entire disclosure of which is incorporated herein by reference for all purposes.

### BACKGROUND

### 1. Field of the Invention

One or more embodiments relate to a space digital twin device and method for generating and managing a digital twin outer space corresponding to a real outer space by expressing, in a digital twin, space events experienced by the space system while performing a given space mission in the actual outer space.

### 2. Description of the Related Art

In recent years, with the revitalization of space development led by the government and private companies, the areas of space exploration, operation, and utilization are gradually expanding.

The space system may be a means of space exploration, operation, and utilization.

The space system has been mainly operated in the real world in the related art.

In addition, in the related art, the space system is controlled using ground equipment (software and hardware), and if necessary, the space system is simulated using a simulation device for specific parts.

Such a method of operating the space system in the real world has many limitations in operating the space system optimally because it is not real outer space.

Therefore, for the safe and efficient operation of the space system, the introduction and use of a space digital twin device is urgently required.

### SUMMARY

An embodiment of the present disclosure is to provide a space digital twin device and method for strengthening an interconnection relationship between outer space, a space system, a space mission, and a space event to overcome limitations of space simulation devices of the related art.

In addition, an object of an embodiment of the present disclosure is to provide a space digital twin environment, thereby transplanting data of the real world to represent past and present states, and enabling future prediction based on learning and experiences.

According to an aspect, there is provided a space digital twin device including a digital twin unit configured to simulate a space system as a twin space system, a digital control unit configured to transplant control for the space system to control for the twin space system, and a digital output unit configured to visualize a content generated according to the control for the twin space system.

According to another aspect, there is provided a space digital twin method including, by a digital twin unit, simulating a space system as a twin space system, by a digital control unit, transplanting control for the space system to control for the twin space system, and by a digital output unit, visualizing a content generated according to the control for the twin space system.

Additional aspects of embodiments will be set forth in part in the description which follows and, in part, will be apparent from the description, or may be learned by practice of the disclosure.

According to an embodiment of the present invention, it is possible to provide a space digital twin device and method for strengthening an interconnection relationship between an outer space, a space system, a space mission, and a space event to overcome limitations of space simulation devices of the related art.

In addition, according to the present disclosure, by providing a space digital twin environment, it is possible to transplant data of the real world to represent past and present states, and enable future prediction based on learning and experiences.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a space digital twin device according to an embodiment of the present disclosure;

FIG. 2 is a diagram illustrating an overall structure of a space digital twin device of the present disclosure; and

FIG. 3 is a flowchart illustrating a space digital twin method according to an embodiment of the present disclosure.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

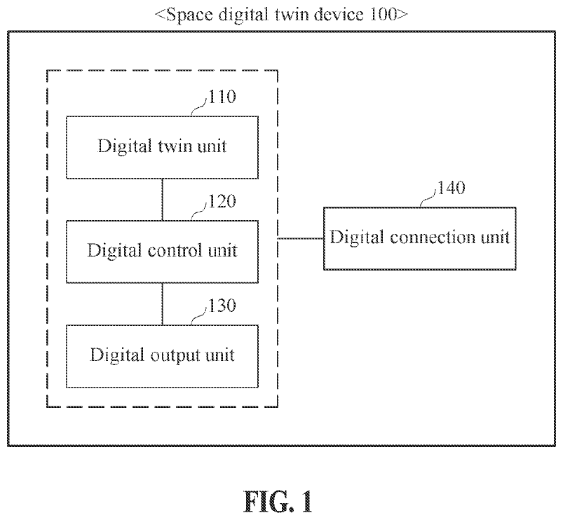

FIG. 1 is a block diagram illustrating a configuration of a space digital twin device according to an embodiment of the present disclosure.

Referring to FIG. 1, a space digital twin device 100 according to an embodiment of the present disclosure may be configured to include a digital twin unit 110, a digital control unit 120, and a digital output unit 130. According to an embodiment, the space digital twin device 100 may be configured by selectively adding a digital connection unit 140.

First, the digital twin unit 110 simulates a space system as a twin space system. In other words, the digital twin unit 110 may copy a real space system as a virtual twin space system.

The digital twin unit 110 may implement the real space system as a virtual space system in a computer to simulate a situation according to the driving of the space system with the computer and predict a driving result in advance.

The digital control unit 120 transplants control for the space system as control for the twin space system. In other words, the digital control unit 120 may apply the control for the real space system to the virtual twin space system.

For example, when a control command “Display highest satellite object” is input in the real space system, the digital control unit 120 may transplant the command as a control command “Display highest satellite object” also in the virtual twin space system.

The digital output unit 130 visualizes a content generated according to the control for the twin space system. In other words, the digital output unit 130 may display the content as a result of simulation by the virtual twin space system.

According to an embodiment, the space digital twin device 100 may apply a digital twin technology even to outer space, a space mission, and a space event.

For this, the digital twin unit 110 may simulate the outer space in which the space system operates as a twin outer space, simulate a space mission assigned in the outer space as a twin space mission, and simulate a space event occurring due to the space mission performed as a twin space event.

The twin outer space may be obtained by simulating a space environment (various types of gravitational fields and disturbance) in orbit.

The twin space mission may be obtained by simulating an operation according to a command sequence transmitted from the ground to the space system or a space mission autonomously performed in the space system.

The twin space event may be obtained by simulating various types of space events experienced by the space system while performing the space mission in the outer space.

Then, the digital control unit 120 may transplant the control for each of the outer space, the space mission, and the space event as the control for each of the twin outer space, the twin space mission, and the twin space event which are additionally simulated.

For example, the digital control unit 120 may transplant a control command generated in relation to the outer space “Orbit A” in which “Satellite No. 1” is orbiting, as a control command in the virtual twin outer space.

In addition, the digital control unit 120 may transplant a control command related to a space mission of capturing a fixed object on the ground by “Satellite No. 1” in the outer space “Orbit A”, as a control command in the virtual twin space mission.

In addition, the digital control unit 120 may transplant, as a control command in a virtual twin space event, a control command related to a space event that notifies an approach of “Satellite No. 2” that approaches “Satellite No. 1” at the time of capturing a fixed object on the ground by “Satellite No. 1” in the outer space “Orbit A”.

According to an embodiment, the space digital twin device 100 may interconnect the space system, the outer space, the space mission, and the space event that are simulated as digital twins.

For this, the space digital twin device 100 may be configured to include the digital connection unit 140.

The digital connection unit 140 may interconnect the twin space system with the twin outer space, the twin space mission, and the twin space event that are additionally simulated. In other words, the digital connection unit 140 may implement various space-related simulations by linking the four simulated digital twins together.

In addition, the digital output unit 130 may, in response to a request from a user terminal, select at least one digital twin among the twin space system, the twin outer space, the twin space mission, or the twin space event, and visualize the content implemented by the selected digital twin.

Specifically, when the request is a “space situation”, the digital output unit 130 may visualize a space situation related to the twin space event and the twin space mission implemented by the twin space system in the twin outer space as the content, by selecting all of the twin space system, the twin outer space, the twin space mission, and the twin space event.

For example, when a request “space situation” related to the capturing of the fixed object on the ground by “Satellite No. 1” in “Orbit A” is input from the user terminal, the digital output unit 130 may capture a satellite image obtained by a twin space mission “capturing of the fixed object on the ground” by “Satellite No. 1” which is orbiting in the twin outer space “Orbit A” in response to the control command by the twin space system, and visualize the captured satellite image and simultaneously visualize a notification for notifying an approach of “Satellite No. 2” which approaches the “Satellite No. 1” when capturing the fixed object on the ground, as the twin space event.

According to an embodiment of the present disclosure, it is possible to provide a space digital twin device and method for strengthening an interconnection relationship between the outer space, the space system, the space mission, and the space event to overcome limitations of space simulation devices of the related art.

In addition, in the disclosure, by providing a space digital twin environment, it is possible to transplant data of the real world to represent past and present states, and enable future prediction based on learning and experiences.

The space system is a system designed to perform a space missions in an outer space and may experience various space events.

The space digital twin device 100 of the present disclosure may represent, in a digital twin, a space event experienced by the space system while performing a given space mission in actual outer space.

The space digital twin device 100 may allow a user to intuitively recognize the space situation through the digital twin and operate and control the real space system.

The space digital twin device 100 may perform generation/management, connection control, and data sharing of a digital twin outer space corresponding to real outer space.

Data about outer space may be information on a space environment (an orbital environment, etc.) and space weather (solar activity, geomagnetic activity, etc.).

The space digital twin device 100 may perform generation/management, connection control, and data sharing of a digital twin space system corresponding to a real space system.

Data about the space system may be information on physical properties (size/appearance/mass/components, etc.) of the space system (a launch vehicle, satellite, probe, space robot, other space equipment).

The space digital twin device 100 may allow confirmation of a past state or a current quasi-real-time state of the orbit, posture, and component by transplanting the actual data of the space system.

The space digital twin device 100 may perform generation/management, connection control, and data sharing of a digital twin space mission corresponding to a real space mission.

The space digital twin device 100 may assign a space mission (transmit an operation command) and check an operation state in real time or non-real time.

The space digital twin device 100 may perform generation/management, connection control, and data sharing of a digital twin space event corresponding to a real space event.

The space digital twin device 100 may detect or generate an event such as an approaching state with other space systems and space objects (including rendezvous, docking, a proximity operation, etc.)

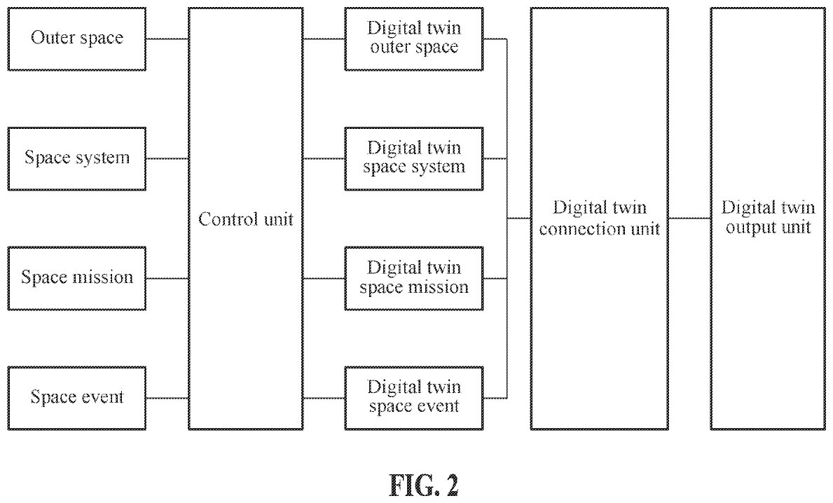

FIG. 2 is a diagram illustrating an overall structure of a space digital twin device of the present disclosure.

As shown in FIG. 2, the space digital twin device 100 may include a control unit, a digital twin connection unit, and a digital twin output unit.

The control unit may connect the control between the real outer space and the digital twin outer space, connect the control between the real space system and the digital twin space system, connect the control between the real space mission and the digital twin space mission, and connect the control between the real space event and the digital twin space event.

The digital twin connection unit may link data of each part in the digital twins by connecting the digital twin outer space, the digital twin space system, the digital twin space mission, and the digital twin space event.

The digital twin output unit may display the digital twins, and contents generated by the simulation in the digital twins. The digital twin output unit may provide a display environment to the user and enable storage and reproduction offline.

The digital twin outer space may be obtained by simulating a space environment (various types of gravitational fields and disturbance) in orbit.

The digital twin space system may simulate the real space system as much as possible according to modeling fidelity, represent a past or present state by inputting actual data, and predict the future using data-based learning and experience.

The digital space mission may include an operation according to a command sequence transmitted from the ground to the space system or a mission autonomously performed in the space system.

The digital space event is various types of events that the space system experiences while performing the space mission in the outer space, and mutual interference between different space systems may also be considered.

In one digital twin outer space, a plurality of digital twin space systems, digital twin space missions, and digital twin space events may be operated.

The user may log in to the digital twins to generate various types of objects and contents (the outer space, space systems, space missions, and space events), and confirm these through the digital twin output unit.

Depending on the permissions granted, the user may confirm a state of the space system in the digital twin outer space, and recognize a space event and assign a space mission.

The user may confirm a current space state (the space events and space mission of the space system in the outer space) in quasi-real-time, and confirm a pas space state and a future space state, if necessary.

With the space digital twin device of the present disclosure, a current state (an orbit, posture, operation, etc.) of a single or a plurality of artificial satellites may be confirmed.

In addition, with the space digital twin device, a mission (orbit change, posture change, capturing an image, or data transmission, etc.) may be assigned to a single or a plurality of artificial satellites.

Furthermore, the space digital twin device may confirm a mission performance state of a single or a plurality of artificial satellites.

In addition, with the space digital twin device, a space events (proximity operation, rendezvous/docking, etc.) between different artificial satellites may be confirmed.

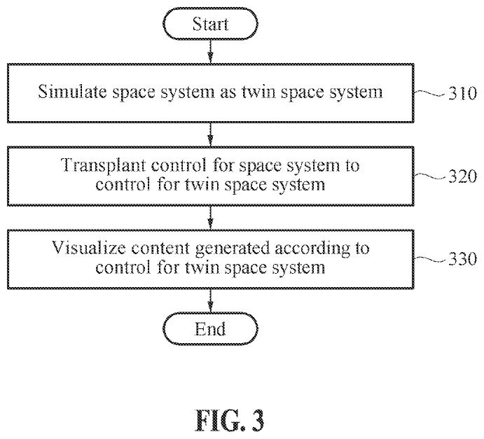

Hereinafter, FIG. 3 specifically illustrates an operation flow of the space digital twin device 100 according to embodiments of the present disclosure.

A space digital twin method according to the present embodiment may be performed by the space digital twin device 100.

FIG. 3 is a flowchart illustrating a space digital twin method according to an embodiment of the present disclosure.

First, in operation 310, the digital twin unit of the space digital twin device 100 simulates a space system as a twin space system. Operation 310 may be a process in which the digital twin unit copies a real space system as a virtual twin space system.

The digital twin unit may implement the real space system as a virtual space system in a computer to simulate a situation according to the driving of the space system with the computer and predict a driving result in advance.

In addition, in operation 320, the digital control unit of the space digital twin device 100 transplants control for the space system to control for the twin space system. Operation 320 may be a process in which the digital control unit applies the control for the real space system to the virtual twin space system.

For example, when a control command “Display highest satellite object” is input in the real space system, the digital control unit may transplant the command as a control command “Display highest satellite object” also in the virtual twin space system.

Subsequently, in operation 330, the digital output unit of the space digital twin device 100 visualizes a content generated according to the control for the twin space system. Operation 330 may be a process in which the digital output unit displays the content as a result of simulation by the virtual twin space system.

According to an embodiment, the space digital twin device 100 may also apply a digital twin technology to the outer space, the space mission, and the space event.

For this, the digital twin unit may simulate the outer space in which the space system operates as a twin outer space, simulate a space mission assigned in the outer space as a twin space mission, and simulate a space event occurring due to the space mission performed as a twin space event.

The twin outer space may be obtained by simulating a space environment (various types of gravitational fields and disturbance) in orbit.

The twin space mission may be obtained by simulating an operation according to a command sequence transmitted from the ground to the space system or a space mission autonomously performed in the space system.

The twin space event may be obtained by simulating various types of space events experienced by the space system while performing the space mission in the outer space.

Then, the digital control unit may transplant the control for each of the outer space, the space mission, and the space event as the control for each of the twin outer space, the twin space mission, and the twin space event which are additionally simulated.

For example, the digital control unit may transplant a control command generated in relation to the outer space “Orbit A” in which “Satellite No. 1” is orbiting, as a control command in the virtual twin outer space.

In addition, the digital control unit may transplant a control command related to a space mission of capturing a fixed object on the ground by “Satellite No. 1” in the outer space “Orbit A”, as a control command in the virtual twin space mission.

In addition, the digital control unit may transplant, as a control command in a virtual twin space event, a control command related to a space event that notifies an approach of “Satellite No. 2” that approaches “Satellite No. 1” at the time of capturing a fixed object on the ground by “Satellite No. 1” in the outer space “Orbit A”.

According to an embodiment, the space digital twin device 100 may interconnect the space system, the outer space, the space mission, and the space event that are simulated as digital twins.

For this, the digital connection unit of the space digital twin device 100 may interconnect the twin space system with the twin outer space, the twin space mission, and the twin space event that are additionally simulated. In other words, the digital connection unit may implement various space-related simulations by linking the four simulated digital twins together.

In addition, the digital output unit may, in response to a request from a user terminal, select at least one digital twin among the twin space system, the twin outer space, the twin space mission, or the twin space event, and visualize the content implemented by the selected digital twin.

Specifically, when the request is a “space situation”, the digital output unit may visualize a space situation related to the twin space event and the twin space mission implemented by the twin space system in the twin outer space as the content, by selecting all of the twin space system, the twin outer space, the twin space mission, and the twin space event.

For example, when a request “space situation” related to the capturing of the fixed object on the ground by “Satellite No. 1” in “Orbit A” is input from the user terminal, the digital output unit 130 may capture a satellite image obtained by a twin space mission “capturing of the fixed object on the ground” by “Satellite No. 1” which is orbiting in the twin outer space “Orbit A” in response to the control command by the twin space system, and visualize the captured satellite image and simultaneously visualize a notification for notifying an approach of “Satellite No. 2” which approaches the “Satellite No. 1” when capturing the fixed object on the ground, as the twin space event.

According to an embodiment of the present disclosure, it is possible to provide a space digital twin device and method for strengthening an interconnection relationship between the outer space, the space system, the space mission, and the space event to overcome limitations of space simulation devices of the related art.

In addition, in the disclosure, by providing a space digital twin environment, it is possible to transplant data of the real world to represent past and present states, and enable future prediction based on learning and experiences.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random-access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The devices described above may be configured to act as one or more software modules in order to perform the operations of the embodiments, or vice versa.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network coupled computer systems so that the software is stored and executed in a distributed fashion. The software and data may be stored by one or more non-transitory computer readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A space digital twin device comprising:
a digital twin unit configured to simulate a space system as a twin space system;
a digital control unit configured to transplant control for the space system to control for the twin space system; and
a digital output unit configured to visualize a content generated according to the control for the twin space system.

2. The space digital twin device of claim 1, wherein the digital twin unit is configured to simulate an outer space in which the space system operates as a twin outer space, simulate a space mission assigned in the outer space as a twin space mission, and simulate a space event occurring due to the space mission performed as a twin space event, and
wherein the digital control unit is configured to transplant control for each of the outer space, the space mission, and the space event to control for each of the twin outer space, the twin space mission, and the twin space event that are additionally simulated.

3. The space digital twin device of claim 2, further comprising:
a digital connection unit configured to interconnect the twin space system with the twin outer space, the twin space mission, and the twin space event that are additionally simulated.

4. The space digital twin device of claim 3, wherein the digital output unit is configured to, in response to a request from a user terminal, select at least one digital twin among the twin space system, the twin outer space, the twin space mission, or the twin space event, and visualize the content implemented by the selected digital twin.

5. The space digital twin device of claim 4, wherein, when the request is a “space situation”, the digital output unit is configured to visualize a space situation related to the twin space event and the twin space mission implemented by the twin space system in the twin outer space as the content, by selecting all of the twin space system, the twin outer space, the twin space mission, and the twin space event.

6. A space digital twin method comprising:
by a digital twin unit, simulating a space system as a twin space system;
by a digital control unit, transplanting control for the space system to control for the twin space system; and
by a digital output unit, visualizing a content generated according to the control for the twin space system.

7. The space digital twin method of claim 6, further comprising:
by the digital twin unit, additionally simulating an outer space in which the space system operates as a twin outer space;
by the digital twin unit, additionally simulating a space mission assigned in the outer space as a twin space mission;
by the digital twin unit, additionally simulating a space event occurring due to the space mission performed as a twin space event; and
by the digital control unit, transplanting control for each of the outer space, the space mission, and the space event to control for each of the twin outer space, the twin space mission, and the twin space event that are additionally simulated.

8. The space digital twin method of claim 7, further comprising:
by a digital connection unit, interconnecting the twin space system with the twin outer space, the twin space mission, and the twin space event that are additionally simulated.

9. The space digital twin method of claim 8, further comprising:
by the digital output unit, in response to a request from a user terminal, selecting at least one digital twin among the twin space system, the twin outer space, the twin space mission, or the twin space event, and visualizing the content implemented by the selected digital twin.

10. The space digital twin method of claim 9, further comprising:
when the request is a “space situation”, by the digital output unit, visualizing a space situation related to the twin space event and the twin space mission implemented by the twin space system in the twin outer space as the content, by selecting all of the twin space system, the twin outer space, the twin space mission, and the twin space event.
